(19) United States
(12) Patent Application Publication
(10) Pub. No.: US 2004/0195042 A1
(43) Pub. Date: Oct. 7, 2004

(54) Mobile hunting stand

(76) Inventor: Kenneth B. Smith, Mt. Holly, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/408,403

(22) Filed: Apr. 7, 2003

(51) Int. Cl. E06C 5/00

(52) U.S. Cl. 182/127

(57) ABSTRACT

The present invention consists of an improved hunting stand to be releasably attached to the rear rack area above the rear axle of a factory equipped ATV. The improved hunting stand or platform may be raised from its traveling position just behind the ATV operator to a desired hunting height. The stand may be raised manually by the hunter or automatically through some form of electronic or hydraulic scissor lift mechanism. Retractable outriggers extend from the base of the scissor lift mechanism to rest on the ground and provide additional stability when the stand is used on uneven terrain. Finally, the improved hunting stand includes dry boxes for ammunition storage; rifle supports for steadying a hunter's aim and a foldable or swivel seat to comfortably support the hunter during hunting activities.

### BACKGROUND OF THE INVENTION

1. Field of the Invention

The present invention relates generally to the practice of hunting from a mobile hunting stand. More particularly, the invention relates to a hunting stand that is attached to the rear of an all terrain vehicle and includes a raisable platform.

2. The Prior Art

Many avid hunters, particularly deer hunters, are very cognizant of the need for safety when hunting. As a result, they prefer to shoot from a tree stand positioned approximately 10-12 feet off the ground. Shooting down at the game from this position allows misplaced shots to embed harmlessly into the ground just beyond the target, thereby greatly reducing the risk of striking any unintended targets in the distance. Another advantage of shooting from tree stands is to prevent the wild game, such as deer, from sensing the hunter. Elevated positions avoid the deer's vision, sense of smell and highly developed ability to detect motion. Despite these benefits, tree stands also possess significant deficiencies.

Most tree stands are heavy and inconvenient to transport or they are flimsy and unsafe once erected in trees. Additionally, tree stands by their very description require a hunter to take up position within a tree. This prevents hunters from securing an elevated hunting position in open fields or bluffs, which are often the most preferred surroundings for safely and effectively targeting game. The present invention relates to a highly mobile hunting stand which is not dependent upon trees for providing its elevated support.

Another aspect of hunting is locating the game. Often deer, for example, are not within easy walking distance from a road. To effectively locate the deer, many hunters use all-terrain vehicles, or ATVs as they are commonly known. These vehicles assist hunters in traveling to remote locations where the game is known to congregate. ATVs readily travel on small desolate trails through streams and up steep inclines; providing the hunter with significantly greater mobility than is possible by foot.

One group of known hunting stands provide structures that are affixed to trailers, such that they may be towed to desired hunting locations by trucks or ATVs. The stands are then elevated from their lowered positions aboard the trailers to a desired hunting height. For example, U.S. Pat. No. 5,102,179 to Royer discloses a hunter's blind affixed to a trailer for towing behind an ATV and which is raised to rest on stilts to provide the hunter an elevated hunting position. Another example is U.S. Pat. No. 5,295,555 to Strange which discloses a hydraulic deer stand lift box that is extended from a base support aboard a trailer. Yet another example of a hunting stand attached to a trailer is shown in U.S. Pat. No. 5,564,523 to Howard as a collapsible deer stand held in an elevated position by a plurality of rigid, removable cross-braces. U.S. Pat. No. 6,460,653 to Hardy et al. discloses a hunting blind comprising a combination hydraulic seat lift and trailer that is attached to a trailer for transport and which is lifted to a desired hunting height by a scissor lift mechanism.

The above described hunting stands have significant limitations that generally flow from their use of a trailer to transport and support the stand during use. First, the use of a trailer limits the mobility of the ATV and accordingly the hunter by restricting an ATV's ability to negotiate tight corners or cross streams. As a result, a hunter may be precluded from hunting in remote or desolate areas. Second, the trailer itself adds unnecessary and often prohibitive cost to the hunting stand apparatus. Finally, trailers lack the necessary stability to support hunters when hunting at significant heights. Generally, only two wheels and a few small outriggers support the hunting trailers. As a result, a single misplacement of an outrigger may result in instability of the trailer and hunting stand. When in use, such instability may result in serious injury to the hunter.

Another group of known hunting stands are attached directly to the ATV itself rather than to a distinct trailer as discussed above. For example, U.S. Pat. No. 4,625,831 to Rogers, Jr. discloses a hunting stand mounted to the rack of an ATV that supports a hunter in an elevated hunting position when parked near and leaned against a tree. U.S. Pat. No. 4,696,374 to Hale discloses a hunting stand comprising a permanent support deck, a collapsible chair and rear support pedestals attached to a carrier for supporting a hunter. U.S. Pat. Nos. 4,800,986 to Hayes, III and 5,042,614 to Rainey disclose collapsible A-frame towers having platforms supported by front and rear segments that are secured to the front and rear racks of an ATV. U.S. Pat. No. 5,409,801 to Reeves discloses a hunting apparatus having a seat supported by a plurality of hunting stand legs that are pivotally mounted to the rear portion of an ATV. The above described hunting stands are deficient in one way or another. First, each of the ATV mounted hunting stands lack adequate stabilizing support for safe and effective hunting from an elevated position. Second, in most cases the ATV stands discussed above require significant and time-consuming installation. Third, should a hunter successfully wound his prey, these ATV stands generally require time-consuming disassembly before the hunter may safely give chase aboard the ATV.

Lastly, U.S. Pat. No. 6,439,635 to Hardy et al. is directed to a hydraulic seat lift for all-terrain vehicles. A stationary lift frame is built onto a modified ATV. An operator's chair is attached to a top platform. The frame and platform are connected with one another by a hydraulic scissor-lift mechanism. The scissor lift mechanism replaces the factory equipped operator seat and most of the rear portion of an ATV. The scissor lift serves to raise the operator's seat platform to an elevated position during hunting. This hunting stand too, suffers significant deficiencies. The hydraulic seat lift requires substantial retrofit to the ATV, which unnecessarily threatens voiding a typical manufacturer's warranty. Apart from a potentially voided manufacturing warranty, the ATV owner faces the exorbitant costs generated by such retrofits. Also, the Hardy stand is not readily removable from the ATV during non-hunting activities. Finally, the Hardy stand may compromise the safe operation of the ATV by replacing a rigidly attached factory equipped operator seat with a non-standard operator seat marginally connected to the ATV via telescoping scissor braces. Over time and use this connection may be subjected to substantial vibration and wear. Should the connection fail, an operator risks serious injury from being thrown from a moving ATV.

Thus, a hunting stand is needed that safely and comfortably raises a hunter to an elevated position during hunting. It is highly desirable for the hunting stand to have maximum mobility accomplished by a robust design, which allows for ready attaching and detaching of the hunting stand to a factory equipped ATV. It is further desirable that the ATV not undergo any substantial, costly or warranty voiding retrofit to accommodate the hunting apparatus. Another need is for the hunting stand to quickly raise and lower allowing a hunter to speedily transition between hunting and traveling applications.

### BRIEF SUMMARY OF THE INVENTION

The above and other needs are met by the present invention which, includes an improved hunting stand to be detachably mounted to the factory equipped, rear storage rack area of an all-terrain vehicle or ATV. The improved hunting stand or platform may be raised from its traveling position just behind the ATV operator to a desired hunting height above the ground. The stand may be raised manually by the hunter or automatically through some form of electronic or hydraulic mechanism. A preferred embodiment of the present invention includes lifting the hunting platform via a scissor lift assembly connected to the rear rack area of an ATV. Retractable outriggers may extend from the base of the scissor assembly to rest on the ground so as to provide additional support and stability during use. Finally, the improved hunting stand of the present invention includes dry boxes for ammunition storage, safety rails for preventing an accidental fall, rifle supports for steadying a hunter's aim and a foldable seat to comfortably support the hunter during hunting.

Detachably mounting the improved hunting stand of the present invention to the rear rack area of a factory equipped ATV provides hunters with several significant benefits. First, it allows the hunter an elevated hunting position while targeting prey so as to maximize hunting safety and avoid detection by the game. Second, it allows the hunter to take advantage of the increased mobility and payload capacity of the ATV while hunting. Third, the compact size and design of the present invention allow ready attachment to a factory equipped ATV thereby reducing upfit costs and eliminating the need for massive, warranty nullifying alteration of the ATV. Fourth, the use of a four wheeled ATV coupled with retractable outriggers provides ample stability regardless of the irregularity of the base terrain. Fifth, the use of dry boxes, rifle supports and a foldable hunting seat maximizes the effectiveness and comfort of a hunter during the hunt.

A primary object of the present invention is to provide a hunting stand designed to replace the factory equipped rear rack of an all terrain vehicle that is capable of comfortably and safely lifting a hunter to a desired hunting height.

Another object of the present invention is to provide a hunting stand which may be readily attached and detached from a factory equipped ATV so as to prevent any limitation of the ATV's non-hunting utility.

Yet, another object of the present invention is to provide a hunting stand attached in place of the rear rack of an ATV which is capable of lifting a hunter comfortably and safely to a desired hunting height via mechanical, hydraulic or electronic means.

A still further object of the present invention is to provide retractable outriggers attached to the base of the ATV mounted hunting stand to further stabilize the stand during use.

Another object of the present invention is to provide a hunting stand attached to a factory equipped ATV having a foldable hunting seat affixed to the hunting platform and which is capable of collapsing within the platform during non-hunting use of the ATV.

An even further object of the present invention is to provide a hunting stand attached to a factory equipped ATV having a removable hunting seat disposed within the hunting platform that is capable of mounting atop a removable seat stand attached to the hunting platform so as to provide a hunter with swivel capability during hunting.

A still further object of the present invention is to provide a hunting stand attached to a factory equipped ATV with safety rails removably affixed to the hunting platform to prevent accidental falls by the hunter during hunting activity.

A yet further object of the present invention is to provide a hunting stand attached to a factory equipped ATV with removable dry storage boxes and rifle supports removably affixed to the hunting platform to accommodate the efficient use of the platform during hunting activity.

Additional objects of the present invention will appear as the description proceeds.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an isometric view of known prior art. Specifically, a factory equipped ATV having front and rear detachably-mounted, factory equipped storage racks.

FIG. 2 depicts a side view of the mobile hunting stand according to the present invention taken along line 2-2; including a raisable hunting platform attached in place of the rear rack assembly of an all-terrain vehicle and supported by retractable outriggers.

FIG. 3 illustrates the top view of the preferred hunting stand taken along line 3-3; having a foldable seat, dry storage boxes and safety rails. Also depicted, is the efficient placement of the hunting stand relative to the factory-equipped seat of the ATV.

FIG. 4 is a section view of one embodiment of the mobile hunting stand taken along line 4-4; illustrating a preferred hydraulic scissor lift mechanism for raising the hunting platform to a desired hunting position.

FIG. 5 depicts a rear view of the preferred hunting stand taken along line 5-5; illustrating the transition from a lowered to an elevated hunting position.

FIG. 6 shows a second preferred embodiment of the claimed invention having a raised seat to accommodate swivel action thereby allowing hunters a 360 degree field of vision.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

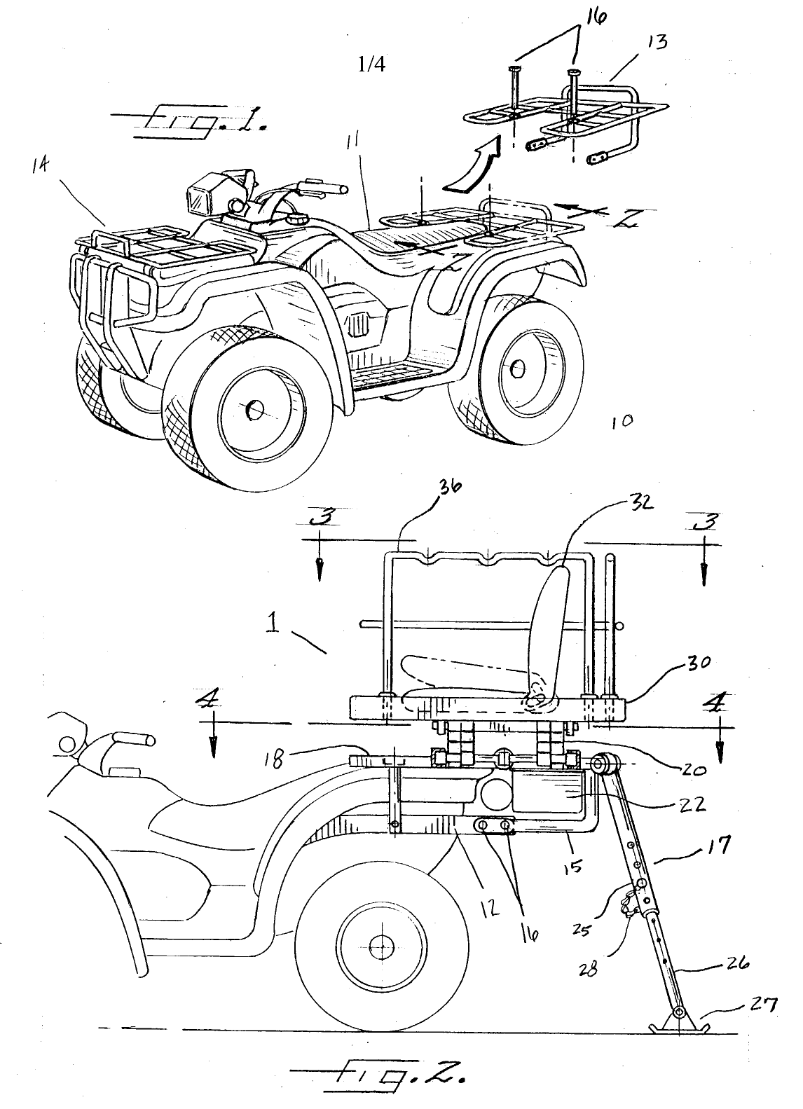

Referring now in more detail to the drawings, FIG. 1 depicts an all terrain vehicle or ATV 10, well known in the art having a factory-equipped operator seat 11, front rack 14, and rear rack 13. Further, FIG. 1 illustrates the detachable nature of traditional factory equipped rear racks 13. The precise method of rear rack attachment and detachment may differ slightly depending on the particular ATV manufacturer. The attachment method illustrated in FIG. 1 has been provided solely for illustration purposes and should not be viewed as limiting. The present invention may be readily slotted, molded or modified to accommodate any form of rear rack attaching configuration.

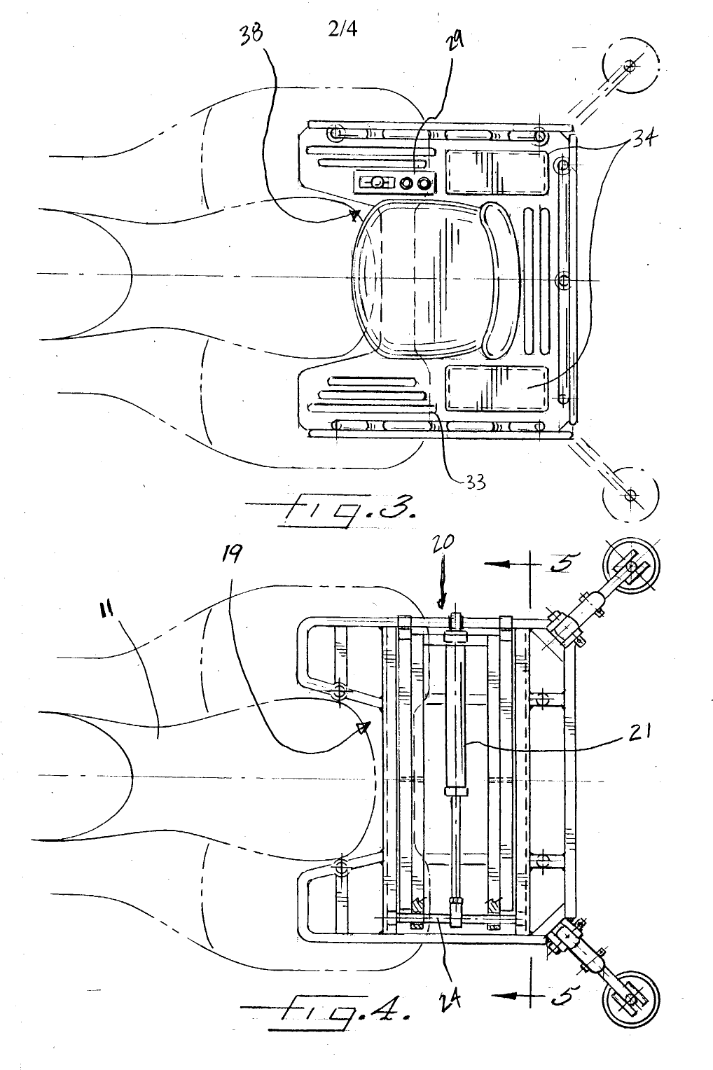

In the preferred embodiment of the present invention illustrated in FIG. 2, a hunting stand 1 is releasably attached to an ATV 10 in place of the factory equipped rear rack 13 (shown in FIG. 1). The hunting stand 1 is comprised of a hunting platform 30 affixed to a lower platform 18 via a scissor lift mechanism 20 that serves to raise the hunting platform to a desired hunting height. A platform support bracket 15 provides stabilizing support to reinforce the rear portion of the lower platform 18 as shown in FIG. 2. To install the preferred hunting stand 1 aboard an ATV in accordance with the present invention, the factory equipped rear rack 13 is removed from the ATV 10 by first removing the rear rack bolts 16 as shown in FIG. 1. Once the rear rack bolts 16 have been removed the factory equipped rear rack 13 is disengaged from the structural frame 12 of the ATV 10. The mobile hunting stand 1 is positioned in place of the rear rack 13 as illustrated in FIG. 2. The rear rack bolts 16 are then replaced, through the lower platform 18 and the platform support bracket 15, so as to fasten both to the ATV frame 12. As a result, the hunting stand 1 is rigidly attached the ATV 10 without need for costly retrofit or modification.

FIG. 2 depicts a side view of an installed hunting stand in accordance with the present invention. Attached at the rear of the hunting stand 1 are two retractable outriggers 15 that are affixed to the lower platform 18 to stabilize the platform during hunting activities. The outriggers 15 are comprised of an upper member 25, a lower member 26, and a foot 27. The upper member 25 cooperates with the lower member 26 so as to provide telescoping action to the outrigger 15. The lower member 26 is locked in a desired position relative the upper member by a pin 28. The foot 27 is pivotally connected to the lower member 26 as shown, to accommodate stable support of the stand regardless of the terrain. The upper member 25 is pivotally attached to the lower platform 18 to allow the outriggers 15 to be pivotally retracted proximate to the lower platform 18 for compact storage of the hunting stand 1 when not in use.

FIG. 3 illustrates a top view of the preferred hunting stand 1 in accordance with the present invention. The lower platform 18 and the hunting platform 30 each have platform detents 19 and 38 respectively, positioned to envelop the rear portion of the factory ATV seat 11 as shown. These detents 19 and 38 allow for ready attachment and detachment of the hunting stand 1 without need for alteration of the factory ATV seat 11.

A foldable hunting seat 32 is positioned on the hunting platform 30 so as to accommodate a hunter during hunting activity. During non-hunting activity the foldable hunting seat 32 collapses into the hunting platform 30 such that the seat back is folded horizontally, to be aligned with the hunting platform 30 thereby creating a flat storage surface. When in use, the foldable seat 32 is folded to an upright, substantially vertical position to provide back support for the hunter during hunting activities. A formed hunting seat detent 31 is positioned beneath the foldable seat 32 so as to accept the folded seat during non-use and accommodate the flat storage surface aboard the hunting platform 30.

Also depicted in FIG. 3 and attached to the hunting platform 30 are storage boxes 34, an electronic lift controller 9 and a plurality of safety rails 36. The storage boxes 34 are positioned to accommodate storage of various hunting supplies while the electronic lift controller 9 provides convenient lift control for hunters during use. The safety rails 36 are provided on the perimeter of the hunting platform 30 to prevent the hunter from accidentally falling from the raised hunting stand during use. The safety rails 36 may be optionally outfitted with rifle stands 37 or rifle detents 37′ as shown in FIG. 2 to steady a hunter's aim when targeting game. Finally, vents 33 may also be added to the hunting platform 30 so as to reduce platform weight.

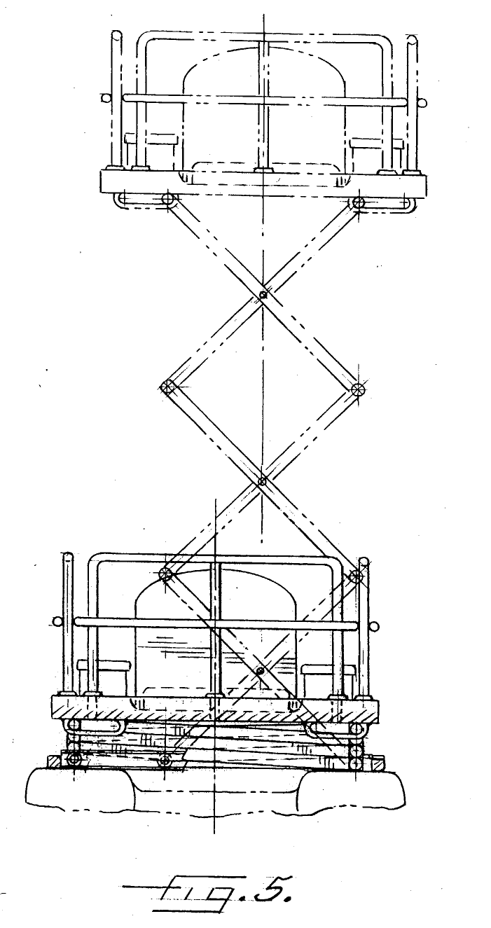

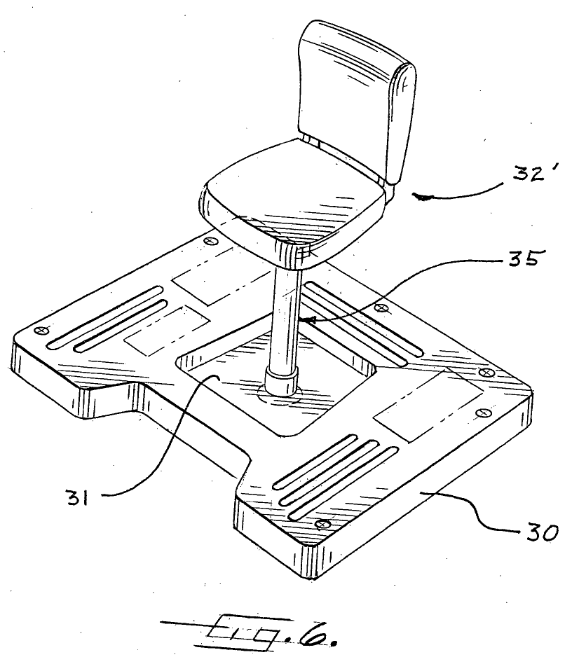

Turning to FIG. 4, shown therein is a top section view of one preferred embodiment of the scissor lift mechanism 20 of the present invention. Although the scissor lift mechanism 20 illustrated in FIG. 4 is depicted as driven by a retracting hydraulic cylinder 21, in fact, electromechanical, pneumatic or manual winch-type crank means may optionally be used. In the embodiment shown, the retracting hydraulic cylinder 21 is attached at one end to a stationary member 23 of the scissor lift mechanism 20 while the opposing end is attached medially to a lift bar 24. The ends of the lift bar 24 are attached to the base of standard scissor braces 29 affixed on opposing sides of the lower platform 18 as shown. The configuration and function of standard scissor braces 25 are well known in the art. As the retracting hydraulic cylinder 21 retracts, the lift bar 24 is translated laterally, toward the stationary member 23 thereby forcing the telescoping action of the scissor braces 25 as shown in FIG. 5. The retracting hydraulic cylinder 21 is powered in this embodiment by a DC motor and compressor 22 affixed to the underside of the lower platform 18 (shown in FIG. 2).

Turning to FIG. 6, shown therein is another embodiment of the present invention having a foldable and removable seat 32′ and a seat stand 35. When in use, the foldable and removable seat 32′ is removed from the hunting platform 30 and the seat stand 35 is attached to the hunting platform 30 proximate to the hunting seat detent 31 as indicated. The foldable and removable seat 32′ is positioned directly on top of the seat stand 35 so as to accommodate swivel thereby providing a hunting with a 360 degree field of vision during hunting activity.

Many modifications and other embodiments of the inventions set forth herein will come to mind to one skilled in the art to which these inventions pertain having the benefit of the teachings presented in the foregoing descriptions and the associated drawings. For example, the hunting stand of the present invention may readily be applied to the front storage rack of an ATV with slight modification. Additionally, camouflage netting or other equivalent masking apparatus may be provided to reduce the visibility of the scissor braces or hunting stand assembly during use. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hunting stand comprising:
an All-Terrain Vehicle (ATV) having a factory equipped rear rack a lower platform assembly sized and positioned to replace the factory equipped rear rack of the ATV;
a raisable hunting platform for supporting a hunter during hunting activity;
a scissors lift mechanism affixed to the lower platform assembly and the raisable hunting platform for elevating the hunter and the raisable hunting platform to a desired hunting height.

2. The hunting stand of claim 1, further comprising:
a plurality of outriggers retractably connected to said lower platform assembly for engaging the ground and thereby providing stabilizing support to the ATV during use of the hunting stand.

3. The hunting stand of claim 1, further comprising:
a hunting seat affixed to the raisable hunting platform for assisting the hunter in the comfortable enjoyment of hunting activities.

4. The hunting stand of claim 1, further comprising:
at least one rifle support attached to the raisable hunting platform for steadying the hunter's aim during hunting activity.

5. The hunting stand of claim 1, further comprising:
at least one safety rail removably attached to the raisable hunting platform for securing a hunter aboard the raisable hunting platform during hunting activity.

6. The hunting stand of claim 1, further comprising:
at least one storage container affixed to the raisable hunting platform for storing hunting supplies.

7. The hunting stand of claim 1, wherein the scissors lift mechanism is automated.

8. The hunting stand of claim 6, wherein the scissors lift mechanism is actuated by the hunter via an electronic controller.

9. The hunting stand of claim 1, wherein the scissors lift mechanism is manually raised by an operator.

10. A hunting stand comprising:
an All-Terrain Vehicle (ATV) and a rack assembly including:
a raisable hunting platform for supporting a hunter during hunting activity;
a scissors lift mechanism affixed to the raisable hunting platform for elevating the hunter and the raisable hunting platform to a desired hunting height;
wherein the rack assembly is integral to a factory equipped rack of the ATV.

11. The hunting stand of claim 10, wherein the rack assembly is detachably connected to the ATV to facilitate release of said hunting stand during non-hunting activity.

12. The hunting stand of claim 10, further comprising:
a plurality of outriggers retractably connected to said rack assembly for engaging the ground and thereby providing stabilizing support to the ATV during use of the hunting stand.

13. The hunting stand of claim 10, further comprising:
a hunting seat affixed to the raisable hunting platform of the rack assembly for assisting the hunter in the comfortable enjoyment of hunting activities.

14. The hunting stand of claim 10, further comprising:
at least one rifle support attached to the raisable hunting platform of the rack assembly for steadying the hunter's aim during hunting activity.

15. The hunting stand of claim 10, further comprising:
at least one safety rail removably attached to the raisable hunting platform for securing a hunter aboard the raisable hunting platform during hunting activity.

16. The hunting stand of claim 10, further comprising:
at least one storage container affixed to the raised platform of the rack assembly for storing hunting supplies.

17. The hunting stand of claim 10, wherein the scissors lift mechanism of the rack assembly is automated.

18. The hunting stand of claim 17, wherein the scissors lift mechanism is actuated by the hunter via an electronic controller.

19. The hunting stand of claim 10, wherein the scissors lift mechanism of the rack assembly is manually raised by an operator.
